(19) United States
(12) Patent Application Publication
(10) Pub. No.: US 2016/0353403 A1
(43) Pub. Date: Dec. 1, 2016

(54) NETWORK CONNECTION CONTROLLING SYSTEM AND ELECTRONIC DEVICE EMPLOYING SAME

(71) Applicant: FIH (HONG KONG) LIMITED, Kowloon (HK)

(72) Inventor: AN-TSE LIU, New Taipei (TW)

(21) Appl. No.: 14/794,270

(22) Filed: Jul. 8, 2015

(30) Foreign Application Priority Data
May 29, 2015 (TW) 104117542

(51) Int. Cl. H04W 64/00; H04W 24/02; H04W 4/02

(52) U.S. Cl. CPC H04W 64/003; H04W 4/02; H04W 24/02

(57) ABSTRACT

A network connection controlling system includes a positioning module, a detection module and a management module. The positioning module locates the electronic device. The detection module detects network connection corresponding to location information located by the positioning module. The management module creates and optimizes a network connection distribution table according to the location information of the positioning module and corresponding network connection information of the detection module. The network connection controlling system switches the network connection of the electronic device to a corresponding network according to the network connection distribution table. An electronic device employing the network connection controlling system is also provided.

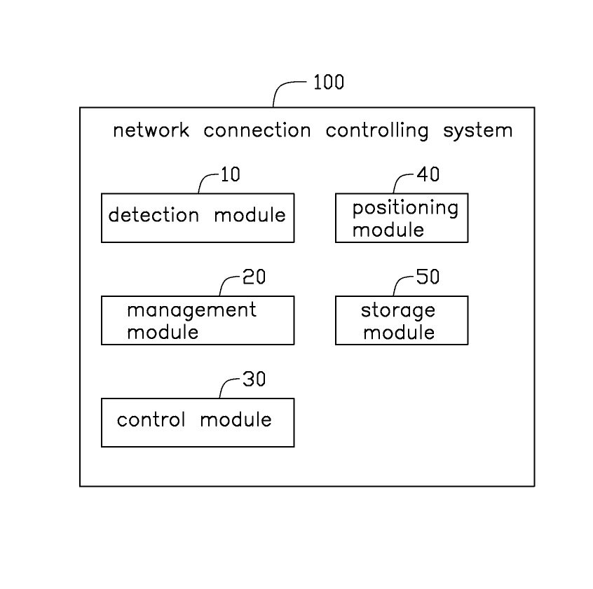

### FIELD

The subject matter herein generally relates to a network connection controlling system, and particularly relates to a network connection controlling system and an electronic device capable of controlling network connection according to user's habit.

### BACKGROUND

Electronic devices need to connect to network at most of time. However, when the electronic device is in a data network and wireless network environment, the electronic device may keep connecting to data network when switching to a wireless network environment, or may keep connecting to the wireless network when the wireless signal strength is weak. The situation may render the electronic device cannot make a best network connection. Therefore, a network connection controlling system can automatically connect to network with best signal strength is needed.

### BRIEF DESCRIPTION OF THE DRAWINGS

Implementations of the present technology will now be described, by way of example only, with reference to the attached figures.

The figure is a block diagram of at least one embodiment of a network connection controlling system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

The figure illustrates at least one embodiment of a network connection controlling system 100 applied in an electronic device. The electronic device may be a smart mobile phone, a laptop computer, and a personal digital assist. The network connection controlling system 100 is configured to automatically switch connections in a multiple network environment. The multiple network environment includes at least a wireless network and a data network. The data network may be a 3G/4G data network provided by telecommunications operators. The wireless network may be a Wi-Fi network provided by Wi-Fi access points.

The network connection controlling system 100 includes a detection module 10, a management module 20, a control module 30, a positioning module 40, and a storage module 50.

The detection module 10 is configured to detect network signals and corresponding signal strength. When the electronic device in a network environment, the detection module 10 detects network signals of current location, including identifying a service set identifier (SSID) of at least one wireless network and data network and corresponding signal strength. The detection module 10 also detects a current network connection of the electronic device. In at least one embodiment, the detection module 10 detects wireless signals and corresponding signal strength of the networks at several locations that the electronic device user usually stays in daily life. For instance, the network can be a family wireless network when user is at home and an office wireless network when user is at the office.

The management module 20 is configured to create and optimize a network connection distribution table according to the detection of the detection module 10. In at least one embodiment, the network connection distribution table includes network signal detected by the detection module 10, corresponding signal strength, time and location of positioning module 40. The network connection distribution table is configured to record network connection conditions of some frequent locations of the electronic device in all time.

The control module 30 is configured to control network connection of the electronic device. The control module 30 automatically switches network connection of the electronic device according to the network connection distribution table or switches according to a switching instruction input by user.

The positioning module 40 is configured to locate the electronic device. The positioning module 40 locates the electronic device in all time to record daily activity habit of the electronic device user.

The storage module 50 is configured to store network connection detecting information of the detection module 10, locating information of the positioning module 40 and the network connection distribution table.

Table 1 illustrates an initial network connection distribution table according to daily habit of the electronic device user. The initial network connection distribution table includes networks the electronic device connected to, corresponding time and location. For instance, during 0:00-6:00 and 21:00-24:00 of working days, the user stays at home, a current location located by the positioning module 40 is home, a network connection detected by the detection module 10 is family wireless network. During 6:00-9:00 and 18:00-21:00 of working days, the user is on the way between home and the office or in outdoor activity, the network connection detected by the detection module 10 is data network. During 9:00-18:00 of working days, the user works in the office, the current location located by the positioning module 40 is office, the network connection detected by the detection module 10 is office wireless network. The initial network connection distribution table records network signals in different time and location.

TABLE 1
initial network connection distribution table

| Time | Sun. | Mon. | Tues. | Wed. | Thurs. | Fri. | Sat. |
|---|---|---|---|---|---|---|---|
| 21:00-6:00 | Family | Family | Family | Family | Family | Family | Family |
| | wireless | wireless | wireless | wireless | wireless | wireless | wireless |
| | network | network | network | network | network | network | network |
| 6:00-9:00 | Family | Data | Data | Data | Data | Data | Family |
| | wireless | network | network | network | network | network | wireless |
| | network | | | | | | network |
| 9:00-12:00 | Family | Office | Office | Office | Office | Office | Family |
| | wireless | wireless | wireless | wireless | wireless | wireless | wireless |
| | network | network | network | network | network | network | network |
| 12:00-18:00 | Family | Office | Office | Office | Office | Office | Family |
| | wireless | wireless | wireless | wireless | wireless | wireless | wireless |
| | network | network | network | network | network | network | network |
| 18:00-21:00 | Family | Data | Data | Data | Data | Data | Family |
| | wireless | network | network | network | network | network | wireless |
| | network | | | | | | network |

The network connection controlling system 100 optimizes the initial network connection distribution table according to further schedule details of the user. Table 2 illustrates a wireless distribution table recording wireless signals and corresponding signal strength at several locations. In at least one embodiment, location 1 maybe at home, location 2 maybe in the office, and location 3 maybe in a meeting room. AP-1 maybe the family wireless network and AP-2 maybe the office wireless network. The detection module 10 detects the AP-1 with a strong signal strength and the AP-2 with a weak signal strength when at home. The detection module 10 detects the AP-2 with a strong signal strength and the AP-1 with a weak signal strength when in the office. The detection module 10 detects the AP-2 with a fair signal strength and the AP-1 with a weak signal strength also when in the office. In at least one embodiment, there may be more than one wireless network at each location, the detection module 10 detects the wireless network that the electronic device most frequently connected to and records to the wireless distribution table.

TABLE 2
wireless distribution table

| | Wireless network | | |
|---|---|---|---|
| Location | distribution | SSID | Signal strength |
| location 1 | AP-1 | AAAA | strong |
| | AP-2 | BBBB | weak |
| location 2 | AP-1 | AAAA | weak |
| | AP-2 | BBBB | strong |
| location 3 | AP-1 | AAAA | weak |
| | AP-2 | BBBB | fair |

Table 3 illustrates a location profile table recording locations of the electronic device in all time of a week. Wherein in a period of 6:00-9:00 and 18:00-21:00, the positioning module 40 cannot locate a fixed location since the user on the way or in activity outdoor.

TABLE 3
location profile table

| Time | Sun. | Mon. | Tues. | Wed. | Thurs. | Fri. | Sat. |
|---|---|---|---|---|---|---|---|
| 21:00-6:00 | location1 | location1 | location1 | location1 | location1 | location1 | location1 |
| 6:00-9:00 | location1 | N/A | N/A | N/A | N/A | N/A | location1 |
| 9:00-12:00 | location1 | location2 | location2 | location2 | location2 | location2 | location1 |
| 12:00-18:00 | location1 | location2 | location2 | location3 | location3 | location2 | location1 |
| 18:00-21:00 | location1 | N/A | N/A | N/A | N/A | N/A | location1 |

Table 4 illustrates an optimized network connection distribution table recording optimized network connection distribution information. The management module 20 optimizes the initial network connection distribution table according to the wireless network distribution table of the detection module 10 and the location profile table of the positioning module 40. Wherein the management module 20 defines the network connection at location 2 is office wireless network for the AP-2 has strong signal strength at location 2. The management module 20 defines the network connection at location 3 is data network for the AP-1 and AP-2 have not strong enough signal strength at location 3, thus to ensure the stability of the network signal.

TABLE 4
optimized network connection distribution table

| Time | Sun. | Mon. | Tues. | Wed. | Thurs. | Fri. | Sat. |
|---|---|---|---|---|---|---|---|
| 21:00-6:00 | Family | Family | Family | Family | Family | Family | Family |
| | wireless | wireless | wireless | wireless | wireless | wireless | wireless |
| | network | network | network | network | network | network | network |
| 6:00-9:00 | Family | Data | Data | Data | Data | Data | Family |
| | wireless | network | network | network | network | network | wireless |
| | network | | | | | | network |
| 9:00-12:00 | Family | Office | Office | Office | Office | Office | Family |
| | wireless | wireless | wireless | wireless | wireless | wireless | wireless |
| | network | network | network | network | network | network | network |
| 12:00-18:00 | Family | Office | Office | Data | Data | Office | Family |
| | wireless | wireless | wireless | network | network | wireless | wireless |
| | network | network | network | | | network | network |
| 18:00-21:00 | Family | Data | Data | Data | Data | Data | Family |
| | wireless | network | network | network | network | network | wireless |
| | network | | | | | | network |

The control module 30 switches network connection of the electronic device to defined network according to the optimized network connection distribution table. When the electronic device changes locations, the detection module 10 detects current network connection and compares to the network connection distribution table. The management module 20 is triggered to obtain a defined network connection of the network connection distribution table from the storage module 50 when the detected current network connection does not match the defined network of the network connection distribution table. The management module 20 transmits a switch instruction to the control module 30 to the electronic device connect to the defined network of the network connection distribution table.

When there are more than one wireless network in one location, the detection module 10 detects a wireless network with greater signal strength and compares to the defined network of the network connection distribution table. When the detected current wireless network does not match the defined network of the network connection distribution table, the management module 20 transmits a rejection instruction to the control module 30 to avoid connecting to other wireless networks that not defined in the network connection distribution table.

When the detection module 10 detects a data network and compares to the defined network of the network connection distribution table. When the detected current data network does not match the defined network of the network connection distribution table, the management module 20 transmits a rejection instruction to the control module 30 to avoid connecting to other data networks that not defined in the network connection distribution table.

The control module 30 can switch network connection in response to a switch instruction input by the user in anytime and anywhere.

The network connection controlling system 100 records daily activity habit of the electronic device user including factors of time, location, network signals, and signal strength. The network connection controlling system 100 automatically switch network connection according to daily activity habit of the electronic device user, which makes the network connection more hommization and accurate. In addition, the network connection controlling system 100 can reject switch to other networks that are not defined in the network connection distribution table.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A network connection controlling system applied in an electronic device, the network connection controlling system comprising:
a positioning module configured to locate the electronic device;
a detection module configured to detect network connection corresponding to location information located by the positioning module; and
a management module configured to create and optimize a network connection distribution table according to the location information of the positioning module and corresponding network connection information of the detection module;
wherein the network connection controlling system switches the network connection of the electronic device to a corresponding network according to the network connection distribution table.

2. The network connection controlling system as claimed in claim 1, wherein the positioning module is configured to locate the electronic device in all time period of a week to record location information of all time periods.

3. The network connection controlling system as claimed in claim 2, wherein the detection module is configured to detect network signals and corresponding signal strength at all locations of the location information located by the positioning module.

4. The network connection controlling system as claimed in claim 3, wherein the detection module is configured to detect a service set identifier and corresponding signal strength of at least one wireless network.

5. The network connection controlling system as claimed in claim 3, wherein the network connection distribution table comprises location information in all time period by the positioning module, network signals and corresponding signal strength by the detection module.

6. The network connection controlling system as claimed in claim 5, further comprising a storage module configured to store location information of the positioning module, network connection information of the detection module, and the network connection distribution table.

7. The network connection controlling system as claimed in claim 1, further comprising a control module configured to switch network connection according to the network connection distribution table.

8. The network connection controlling system as claimed in claim 7, wherein the control module is configured to switch network connection in response to switch instruction input by a user of the electronic device.

9. The network connection controlling system as claimed in claim 7, wherein when a location of the network connection controlling system changed, the detection module detects a current network and compares to the network connection distribution table, when the current network does not match a corresponding defined network in the network connection distribution table, the management module is triggered to obtain the corresponding defined network of the network connection distribution table and transmits switch instruction to the control module, therefore the control module switches the electronic device to connect to the corresponding defined network.

10. The network connection controlling system as claimed in claim 7, wherein the detection module detects a current network and compares to the network connection distribution table, when the current network does not match a corresponding defined network in the network connection distribution table, the management module transmits rejection instruction to the control module to avoid connecting to other networks that not defined in the network connection distribution table.

11. An electronic device comprising:
a network connection controlling system comprising:
a positioning module configured to locate the electronic device;
a detection module configured to detect network connection corresponding to location information located by the positioning module; and
a management module configured to create and optimize a network connection distribution table according to the location information of the positioning module and corresponding network connection information of the detection module;
wherein the network connection controlling system switches the network connection of the electronic device to a corresponding network according to the network connection distribution table.

12. The electronic device as claimed in claim 11, wherein the positioning module is configured to locate the electronic device in all time period of a week to record location information of all time periods.

13. The electronic device as claimed in claim 12, wherein the detection module is configured to detect network signals and corresponding signal strength at all locations of the location information located by the positioning module.

14. The electronic device as claimed in claim 13, wherein the detection module is configured to detect a service set identifier and corresponding signal strength of at least one wireless network.

15. The electronic device as claimed in claim 13, wherein the network connection distribution table comprises location information in all time period by the positioning module, network signals and corresponding signal strength by the detection module.

16. The electronic device as claimed in claim 15, further comprising a storage module configured to store location information of the positioning module, network connection information of the detection module, and the network connection distribution table.

17. The electronic device as claimed in claim 11, further comprising a control module configured to switch network connection according to the network connection distribution table.

18. The electronic device as claimed in claim 17, wherein the control module is configured to switch network connection in response to switch instruction input by a user of the electronic device.

19. The electronic device as claimed in claim 17, wherein when a location of the network connection controlling system changed, the detection module detects a current network and compares to the network connection distribution table, when the current network does not match a corresponding defined network in the network connection distribution table, the management module is triggered to obtain the corresponding defined network of the network connection distribution table and transmits switch instruction to the control module, therefore the control module switches the electronic device to connect to the corresponding defined network.

20. The electronic device as claimed in claim 17, wherein the detection module detects a current network and compares to the network connection distribution table, when the current network does not match a corresponding defined network in the network connection distribution table, the management module transmits rejection instruction to the control module to avoid connecting to other networks that not defined in the network connection distribution table.
